(19) United States
(12) Patent Application Publication
(10) Pub. No.: US 2018/0277978 A1
(43) Pub. Date: Sep. 27, 2018

(54) HOLDING FRAME

(71) Applicant: HARTING Electric GmbH & Co. KG, Espelkamp (DE)

(72) Inventors: Alexander SCHÖNFELD, Osnabrück (DE); Heiko Herbrechtsmeier, Bünde (DE); Heiko Meier, Minden (DE)

(21) Appl. No.: 15/756,393

(22) PCT Filed: Sep. 2, 2016
(86) PCT No.: PCT/DE2016/100402

§ 371 Date: Feb. 28, 2018

(30) Foreign Application Priority Data
Sep. 3, 2015 (DE) 10 2015 114 702.5

(51) Int. Cl. H01R 13/506; H01R 13/518; H01R 13/73

(52) U.S. Cl. CPC H01R 13/506; H01R 13/73; H01R 13/518

(57) ABSTRACT

The disclosure relates to a holding frame for retaining plug connector modules and for installing in plug connector housings or for screwing onto wall surfaces, wherein the plug connector modules are inserted into the holding frame and retention means on the plug connector modules interact with recesses or cut-outs provided on opposite wall parts (side parts) of the holding frame. The holding frame is formed of two halves, which are articulated to each other, and the recesses or cut-outs for retaining the plug connector modules are formed in the side parts of the holding frame as openings closed on all sides. The holding frame is folded open in order to insert the plug connector modules and then closed, wherein the plug connector modules are then interlockingly held in the holding frame by the retention means.

### BACKGROUND

### Technical Field

The disclosure relates to a holding frame for retaining plug type connector modules.

Such holding frames serve to retain plug type connector modules, wherein the holding frame is provided with different plug type connector modules and is subsequently inserted in a plug type connector housing and is screwed thereto. In this instance, the holding frame must be mechanically stable in order to be able to withstand the insertion and pulling forces which occur when assembling or separating the plug type connection.

### Description of the Related Art

From the company publication from the company HARTING Elektronik GmbH “Schwere Steckverbinder, Han-Modular, 16 3” (Heavy-duty plug type connectors, Han-Modular, 16 3) there is known a substantially rectangular holding frame which is provided with side walls which extend at right-angles with respect to the assembly plane. The plug type connector modules are in this instance provided with locking hooks which, when the plug type connector modules are inserted into the holding frame, engage with the side walls and are consequently securely retained therein.

DE 197 07 120 C1 discloses a holding frame for retaining plug type connector modules and for installing in plug type connector housings or for screwing to wall surfaces, wherein the plug type connector modules are inserted in the holding frame and retention means on the plug type connector modules cooperate with recesses which are provided in opposing wall portions (side portions) of the holding frame. The holding frame is constructed from two halves which are connected to each other in an articulated manner and in the side portions of the holding frame recesses for retaining the plug type connector modules are formed as openings which are closed at all sides. In this instance, the holding frame is folded open for inserting the plug type connector modules and subsequently closed, wherein the plug type connector modules are then retained by way of the retention means in the holding frame in a positive-locking manner.

A disadvantageous effect with the holding frame known from the prior art is that the plug type connector modules which are inserted into the holding frame have a very large play. The modules are inserted into the frame in a very wobbly manner which is intended to originally ensure a larger tolerance compensation. In the current automated industrial environment, however, significantly lower tolerances are required. This is also not least a result of the automated plugging, that is to say, contacting and disconnecting modular plug type connectors.

### BRIEF SUMMARY

Embodiments of the present invention provide a holding frame of the type mentioned in the introduction in such a manner that the received plug type connector modules are received in the holding frame in the most play-free manner possible. In this instance, the tolerances in the deviation in the position of the plug type connector modules in the plug type connector are intended to be as small as possible. It should nevertheless be ensured that the holding frame has a high level of mechanical stability in order to withstand the insertion and pulling forces when a plug type connection is assembled or separated.

Embodiments of the present invention relate to a holding frame for retaining plug type connector modules. In this instance, the holding frame is provided for installation in plug type connector housings or for screwing to wall faces. The holding frame has opposing elongate side portions which have cooperating recesses (also referred to as cut-outs) for receiving plug type connector modules.

The recesses are constructed as openings which are closed at all sides in the side portions of the holding frame. Plug type connector modules which are intended to be inserted have corresponding retention means (e.g., projections, lugs) which can be received in the openings. As a result of receiving the retention means of the plug type connector modules in the openings of the side portions, the plug type connector modules are retained between the side portions.

The holding frame comprises two halves which are connected to each other in an articulated manner by articulations. The halves can be tilted toward each other by the articulations. By tilting the two halves, the side portions of the holding frame open in such a manner that plug type connector modules can be inserted.

On the two halves of the holding frame there are provided securing ends, relative to which the side portions of the holding frame are arranged in such a manner that, when the holding frame is screwed to a securing face, the halves are orientated in such a manner that the side portions of the holding frame are orientated at an angle greater than 90° with respect to the securing face and at the same time with respect to each other. That is to say, as a result of screwing the securing ends to the securing face, the securing ends are orientated parallel with each other.

At the same time, as a result of the orientation of the side portions according to the invention with respect to the securing ends, the side portions are orientated at an angle greater than 90° relative to the securing face. The orientation of the side portions with respect to the securing face results in the side portions being inclined relative to each other transversely with respect to the longitudinal axis of the holding frame. That is to say that the side portions move toward each other transversely relative to the longitudinal axis. That is to say that the side portions in regions which are associated more closely with the securing ends have a greater spacing from each other than in regions which are associated more remotely (further away) with the securing ends.

The advantages which are achieved with embodiments of the invention involve in particular inserted plug type connector modules being retained not only between the side portions of the holding frame, but also being fixed in a non-positive-locking manner. A movement of the plug type connector modules in the holding frame is thus possible only with great difficulty. Another advantage involves the plug type connector modules after the installation of the holding frame in a plug type connector housing continuing to be secured in the holding frame in a positive-locking manner and consequently on the whole a high level of mechanical stability for receiving or transmitting the insertion and pulling forces of the plug type connection being present.

### BRIEF DESCRIPTION OF THE SEVERAL VIEWS OF THE DRAWINGS

Exemplary embodiments of the invention are illustrated in the drawings and are explained in greater detail below. In the drawings:

FIG. 1 is a view of an open holding frame;

FIG. 2 is a view of a closed holding frame;

FIG. 3 is a sectioned view of a closed holding frame;

FIG. 4 is a sectioned view of a holding frame from the prior art; and

FIG. 5 is a sectioned view of another closed holding frame.

The Figures contain partially simplified schematic illustrations. Occasionally, for elements which are the same but potentially not identical, identical reference numerals are used. Different views of the same elements could be to a different scale.

### DETAILED DESCRIPTION

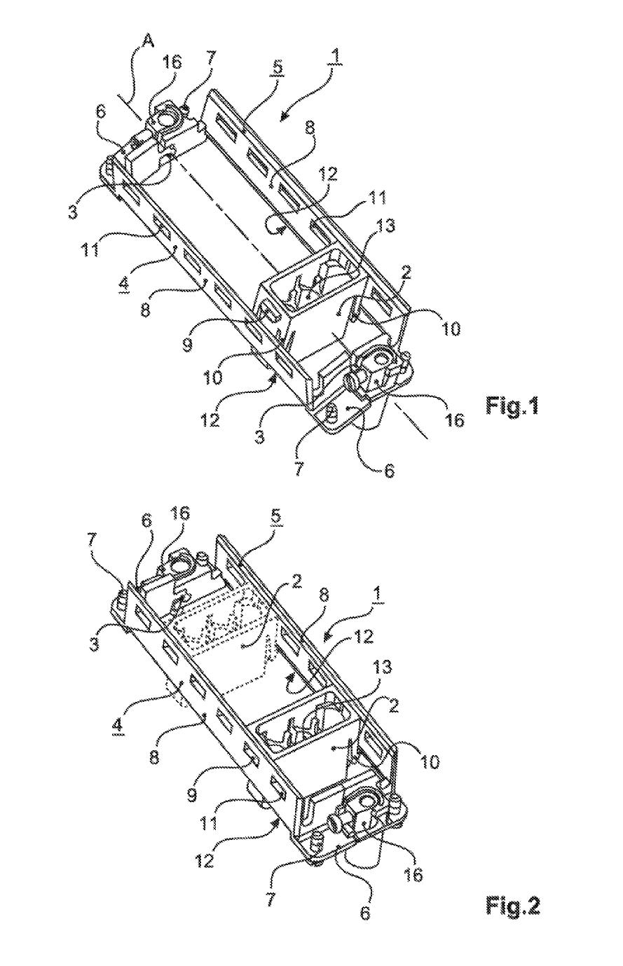

In FIGS. 1 and 2, a holding frame 1 for plug type connector modules 2 is illustrated, wherein in FIG. 1 the holding frame is open and in FIG. 2 it is closed. The holding frame 1 is after the insertion of plug type connector modules 2 provided for installation in plug type connector housings (see FIG. 4 here) or for securing by an aperture of a securing face/assembly wall.

The holding frame comprises two halves 4, 5 which are connected to each other by articulations 3 and which have securing ends 6 which are provided with securing screws 7. The articulations are in this instance provided at the securing ends of the holding frame 1, wherein there is provided the possibility of pivoting the frame halves 4, 5 transversely relative to the side portions 8 of the holding frame 1. In order to form the articulations 3, there are provided at the securing ends 6 of the holding frame 1 or the side portions 8 formations which engage in corresponding recesses. In this instance, these formations are inserted by lateral displacement of the side portions 8 into the recesses, wherein the side portions 8 can subsequently be pivoted (rotated) about the longitudinal axis A.

After the side portions 8 have been assembled, delimitation posts 16 which are constructed in this instance as earthing contacts are inserted into the securing ends 6, wherein the delimitation posts 16 are each provided at the outer ends of the side portions 8 and the articulations 3 are consequently located between the delimitation posts 16. As a result of this arrangement of the delimitation posts 16, an axial displacement of the side portions 8 is prevented.

The plug type connector modules 2 are provided with protruding, substantially rectangular retention means 9 and resilient locking hooks 10. In the side portions 8 of the frame halves 4, 5, there are provided recesses 11 which are constructed as openings which are closed at all sides and in which the retention means 9 are inserted when the plug type connector modules 2 are inserted in the holding frame 1.

In order to insert the plug type connector modules 2, the holding frame 1 is folded open, that is to say, opened, wherein the frame halves 4, 5 are folded open to such an extent about the articulations 3 that the plug type connector modules 2 can be inserted. In order to prefix the plug type connector modules 2, the locking hooks 10 first engage during insertion below the lower edges 12 of the side portions 8 of the frame halves 4, 5.

Subsequently, the frame halves 4, 5 are folded together, that is to say, the holding frame 1 is closed, wherein the retention means 9 reach the recesses 11 and a secure, positive-locking retention of the plug type connector modules 2 in the holding frame 1 is produced.

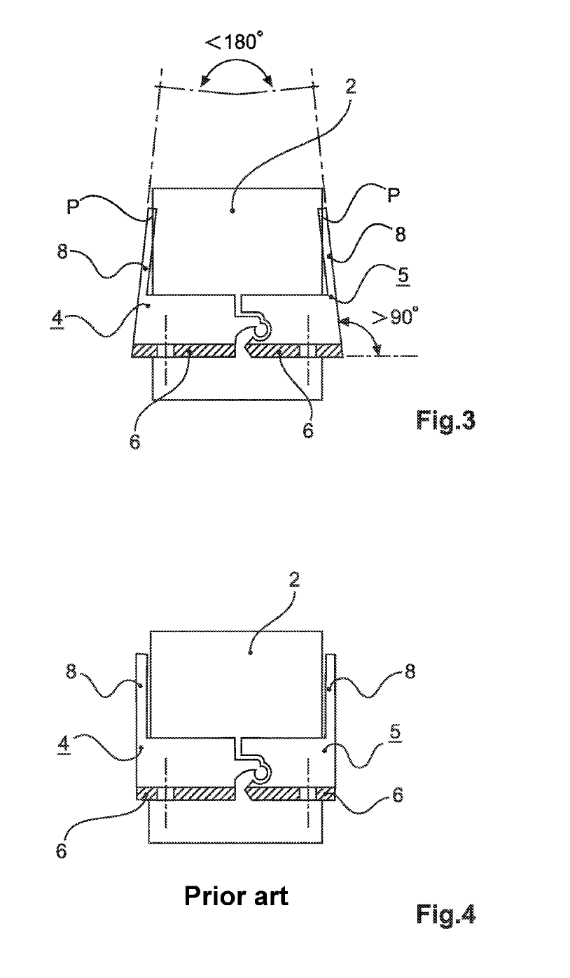

In FIG. 3, the sectioned view of a closed holding frame 1 with an inserted plug type connector module 2 is shown. The plug type connector module 2 is arranged centrally between the two side portions 8. For the sake of clarity, FIGS. 3 and 4 are illustrated schematically. Components such as the retention means 9 and recesses 11 have not been illustrated.

In the illustration, the angle between the securing ends 6 and the side portions 8 is intentionally illustrated on a very large scale in order to better illustrate the notion of embodiments of the invention. The large angle is thus intended to clamp the plug type connector module 2 in the upper region. In the regions P in which the side portions 8 touch the plug type connector module 2, there is thus produced a pressing which fixes the plug type connector module 2 between the halves 4, 5 in a non-positive-locking manner.

At the same time, it can be seen that the two side portions 8 are arranged at an angle less than 180° with respect to each other. This results in the side portions 8 being orientated in an inclined manner with respect to each other.

For greater clarity, in FIG. 4 the same illustration as in FIG. 3 is shown, but in respect of a holding frame 2 as known from the prior art. In this instance, a gap is present between the side portions 2 and the plug type connector module 2. The plug type connector module 2 is thus received in the holding frame 1 only in a positive-locking manner via retention means (not shown) that project from the plug type connector module 2.

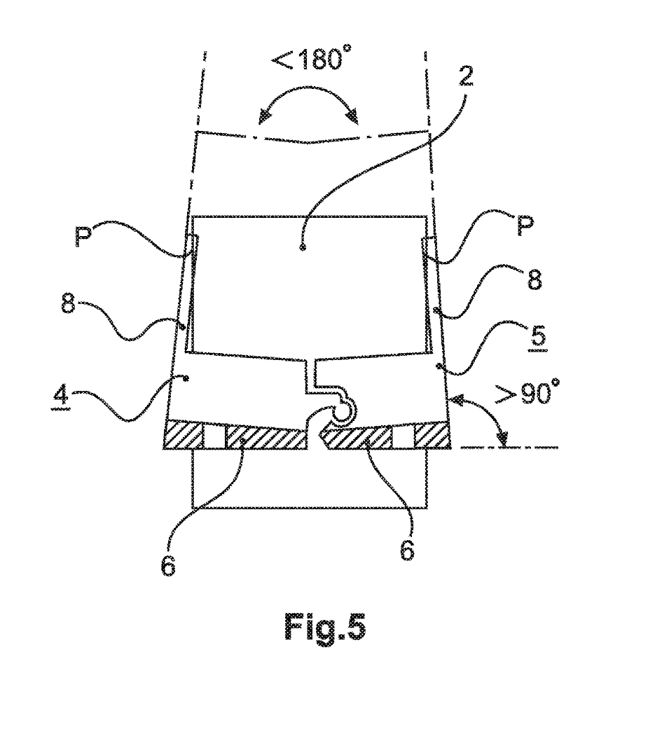

Finally, in FIG. 5 another embodiment of a closed holding frame 1 is illustrated.

In general, in the following claims, the terms used should not be construed to limit the claims to the specific embodiments disclosed in the specification and the claims, but should be construed to include all possible embodiments along with the full scope of equivalents to which such claims are entitled.

1. A holding frame for retaining plug type connector modules and for installing in plug type connector housings or for screwing to wall faces,
wherein the holding frame has opposing side portions which have recesses which cooperate in order to receive the plug type connector modules,
wherein the holding frame comprises two halves which are connected to each other in an articulated manner and which each include a respective one of the side portions and which are connected by two articulations,
wherein the two articulations form a longitudinal axis which is orientated parallel with the side portions and about which the side portions can be rotated, and
wherein securing ends are arranged with respect to the side portions of the holding frame in such a manner that, when the holding frame is screwed onto a securing face, the halves are orientated in such a manner that the side portions of the holding frame are orientated at an angle greater than 90° with respect to the securing face.

2. The holding frame as claimed in claim 1, wherein, when the holding frame is screwed onto the securing face, the side portions are orientated at an angle between 160° and 180°.

3. The holding frame as claimed in claim 1, wherein the side portions in regions which are arranged closer to the securing ends have a greater spacing with respect to each other than in regions which are arranged further from the securing ends.

4. The holding frame as claimed in claim 1, wherein the side portions are arranged at an angle greater than 90° with respect to the securing ends.

5. The holding frame as claimed in claim 1, wherein the recesses are constructed as openings which are closed at all sides in the side portions of the holding frame.
